(19) United States
(12) Patent Application Publication
(10) Pub. No.: US 2012/0276256 A1
(43) Pub. Date: Nov. 1, 2012

(54) ULTRAVIOLET C PATHOGEN DEACTIVATION DEVICE AND METHOD

(75) Inventor: Anthony J.M. Garwood, Mercer Island, WA (US)

(73) Assignee: SAFEFRESH TECHNOLOGIES, LLC, Mercer Island, WA (US)

(21) Appl. No.: 13/324,744

(22) Filed: Dec. 13, 2011

Related U.S. Application Data
(63) Continuation-in-part of application No. 13/024,965, filed on Feb. 10, 2011.
(60) Provisional application No. 61/303,185, filed on Feb. 10, 2010.

(51) Int. Cl. A23B 4/01; A23L 1/025; A23B 4/24; A23B 4/12

(52) U.S. Cl. 426/248; 426/237

(57) ABSTRACT

A method for decontaminating beef is disclosed. The method includes dicing beef into diced particles, chilling the diced particles into chilled particles, compressing and/or flexing the chilled particles to separate fat from the chilled particles to produce fat particles and lean particles, mixing the fat particles and lean particles with a fluid, wherein a density of the lean particles is initially less than a fluid density, treating the lean particles and fat particles with energy harmful to pathogens as the fluid and lean and fat particles pass through an energy-emitting device at least while the lean particles are less dense than the fluid, increasing the temperature of the lean particles to increase the density which causes the lean particles to sink in the fluid, and separating the lean particles from the fat particles.

### CROSS-REFERENCES TO RELATED APPLICATIONS

This application is a continuation-in-part of U.S. application Ser. No. 13/024,965, filed Feb. 10, 2011, which claims the benefit of U.S. Provisional Application No. 61/303,185, filed Feb. 10, 2010, both of which are incorporated herein by reference in their entirety.

### BACKGROUND

Published PCT Application Nos. WO 2006/060596, WO 2006/113543, and WO 2005/099482, by applicant, disclose methods for treating, processing, and separating food products, such as ground beef, into various components and/or the combination of various components into a single meat product having controlled amounts of fat and lean meat. The processing and handling of such food products involves the transporting of materials through pipes, and conduits. A preferred material disclosed in such publications for transporting the food products is liquid carbon dioxide at an elevated pressure, which maintains the carbon dioxide as a liquid. Liquid carbon dioxide can have antimicrobial properties, particularly when combined with a corresponding quantity of water such that the two liquids, when maintained within a pressure vessel or series of interconnecting conduits and pressure vessels, are arranged to allow the combining by mildly exothermic reaction of the two liquid compounds of H₂O+CO₂, which will yield →H₂CO₃ (carbonic acid). To supplement the antimicrobial effect of liquid carbon dioxide, methods and apparatus are continuously being sought to produce safe, sterilized food products, such as meat, and, in particular, cut up or ground meat.

### SUMMARY

Disclosed are an ultraviolet C pathogen deactivation device and a method for using the device in a process for deactivating pathogens while also separating lean meat and tallow from a single boneless beef source.

A method for decontaminating beef is disclosed. The method includes (a) dicing beef into diced particles; (b) chilling the diced particles into chilled particles; (c) compressing and/or flexing the chilled particles to separate fat from the chilled particles to produce fat particles and lean particles; (d) mixing the fat particles and lean particles with a fluid, wherein a density of the lean particles is initially less than a fluid density; (e) treating the lean particles and fat particles with energy harmful to pathogens as the fluid and lean and fat particles pass through an energy-emitting device at least while the lean particles are less dense than the fluid; (f) increasing the temperature of the lean particles to increase the density which causes the lean particles to sink in the fluid; and (g) separating the lean particles from the fat particles. The particles are suspended in fluid to allow rotation of the particles in the fluid as the particles pass through an energy-emitting device.

In one embodiment, the energy used in the method disclosed herein may be UVc energy.

In one embodiment, the temperature of the lean particles is lower than the temperature of the fluid in step (d).

In one embodiment, the temperature of the lean particles is substantially at equilibrium with the temperature of the fluid in step (g).

In one embodiment, the fluid includes water, or water and one of carbon dioxide, an acid, or an alkali agent.

In one embodiment, the energy is UVc energy having a wavelength of 285 nm to 100 nm.

In one embodiment, the method may further include treating the lean particles and fat particles with energy harmful to pathogens as the fluid and lean and fat particles pass through an energy-emitting device during step (f) or step (g).

In one embodiment, the energy-emitting device is disposed vertically or substantially vertical with respect to the ground.

In one embodiment, the method may further include treating separated fat particles with energy harmful to pathogens.

In one embodiment, the method may further include treating separated lean particles with energy harmful to pathogens.

In one embodiment, the chilled particles are individualized particles.

In one embodiment, the chilled particles are solid particles.

A method for decontaminating beef is disclosed. The method includes treating chilled lean particles and fat particles with energy harmful to pathogens as the particles are suspended in fluid to allow rotation of the particles in the fluid as the particles pass through an energy-emitting device.

In one embodiment, as the particles pass through the energy-emitting device, the lean particles are less dense than the fluid

In one embodiment, the energy is UVc energy.

In one embodiment, the temperature of the lean particles is lower than the temperature of the fluid.

In one embodiment, the fluid includes water, or water and one of carbon dioxide, an acid, or an alkali agent.

In one embodiment, the energy is UVc energy having a wavelength of 285 nm to 100 nm.

In one embodiment, the energy-emitting device is disposed vertically or substantially vertical with respect to the ground.

In one embodiment, the chilled particles are individualized particles.

In one embodiment, the chilled particles are solid particles.

### BRIEF DESCRIPTION OF THE FIGURES

The foregoing aspects and many of the attendant advantages of this invention will become more readily appreciated as the same become better understood by reference to the following detailed description, when taken in conjunction with the accompanying drawings, wherein:

FIG. 1 is schematic block diagram of a process for separating fat and lean coupled with pathogen deactivation;

FIG. 2 is a cross-sectional diagrammatical illustration of a device to treat food products;

FIG. 3 is a cross-sectional diagrammatical illustration of the device of FIG. 2; and

FIG. 4 is a cross-sectional diagrammatical illustration of a device to treat food products.

### DETAILED DESCRIPTION

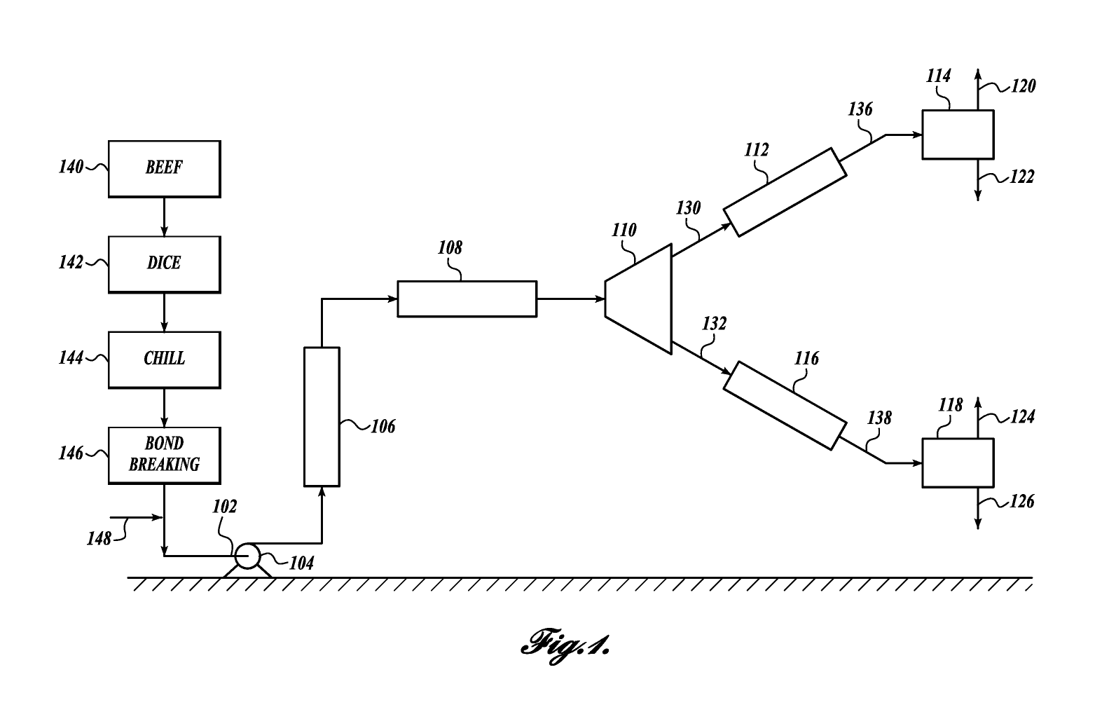

FIG. 1 describes a process for the separation of lean meat from a source of boneless beef while also providing for pathogen deactivation. The process takes beef material comprising both lean and fat and produces at least two products—one high in fat and the other high in lean. The process may be used for concentrating the lean beef from a supply of beef high in fat. Additionally, the process may be used to produce two product streams. A first product stream is lean beef with a percent of fat lower than the incoming supply. A second product stream is fat. Once separated, the fat can be combined with the lean beef to produce lean beef of a predetermined fat content, or the fat may be used in the production of biodiesel. However, a lean beef product may be produced with a predetermined fat content without the need to further add fat. Tallow includes fat and is used interchangeably with fat. Fat and tallow may include other animal tissue besides fat (triglycerides). Similarly, lean beef may include other animal tissue besides muscle (protein).

In block 140, beef is obtained. Beef may be boneless or may include bone and cartilage matter as well. Beef may come from any source. One particular source can be slaughterhouses, which discard trimmings and other less desirable cuts of meat. It is to be appreciated that the reference to beef is for the purpose of illustrating embodiments of the invention. The process of FIG. 1 may be used with pork, chicken, and other types of meat.

In block 142, the beef is prepared into beef particles. The preferred method of particle production is to dice the beef in slicing or dicing equipment using sharp knives to provide 1″ or 2″ sized “cubes.” The dicing equipment is designed to slice and dice the beef and reduce beef to a particle size preferably about 1 inch in cross section by 2 inches or less. While not limiting, the particles are reduced in size to approximately not more than about 1 inch wide and 2 inches long strips or 2 inch cubes. The individual particles of diced beef may still contain an amount of fat and an amount of lean.

The method by which the beef particles are prepared in block 142 prior to treatment by suspension in fluid then transferred adjacent to the UVc light source, is important. For example, conventional grinding will not provide beef (or meat) particles having clean cut surfaces and causes emulsification of a significant proportion of the beef passed through the grinder. Pathogens can, in this way, be protected from the lethal effects of UVc by being encapsulated in emulsified beef when the beef is ground prior to treatment. However, fluid with beef particles suspended therein allows rotation of the beef particles so as to cause exposure of all surfaces of the beef particles to the UVc radiation.

From dicing block 142, beef particles are transferred to chill block 144. Beef particles are chilled in individual quick freezing equipment, such as by passing through a tunnel freezer. The tunnel freezer may use carbon dioxide as the chilling medium. The input temperature of the beef particles to the tunnel may be about 32° F. to 40° F., but preferably about 32° F. The temperature of the beef before the tunnel freezer may be controlled, in general, by adjusting the temperature of the room in which the beef is being diced. Owing to the differences of heat transfer between fat and lean in each beef piece and respective amounts of water in lean versus fat matter, the chilling tunnel results in different temperatures of fat and lean within each beef particle.

The temperature of the individual particles that exit the chilling tunnel is not uniform throughout the particles. Because of the different heat transfer rates of fat and lean as well as the different percentages of water within lean and fat, the temperature of the lean matter will be higher than the temperature of the fat matter within each particle. The temperature reduction in block 144 is carried out to result in lean matter that remains flexible due to the cohesive properties of muscle tissue, while the fat matter is cooled such that the fat matter becomes brittle and friable. Because the lean contains greater amounts of water than fat, the water is frozen or partially frozen.

In one embodiment, flooding the tunnel with carbon dioxide gas displacing what would otherwise be air is advantageous. In this way, carbon dioxide gas can be recycled through evaporators. Another purpose in the use of carbon dioxide is to displace air (and therefore atmospheric oxygen), thereby inhibiting the formation of oxymyoglobin from the deoxymyoglobin exposed at the cut lean surfaces of each dice or beef particle.

The temperature of the quickly frozen beef particles when exiting the tunnel is controlled such that lean matter, comprising substantially muscle striations, will freeze the water and all natural fluids. Water represents about 70% of lean matter and thus the freezing and expansion of water when frozen contributes a significant increase in volume with a corresponding decrease in density of the lean matter. The beef particles from the chill block 144 may still comprise some lean beef matter and some fat matter. The beef particles produced in the chill block 144 are in a solid phase, but in such a way that the physical characteristics and properties of the lean matter is pliable and “rubbery” in texture, while the fat matter is friable such that it fractures when subjected to compressive and twisting actions and will crumble readily into small particles and be freed from the lean matter. The temperature to which the beef particles are reduced needs to alter the physical condition of the beef particles so as to facilitate the flexing of the muscle striations of the lean matter without causing it to fracture and break into smaller pieces, while simultaneously rendering the fat matter friable such that it will fracture, crumble, and break into smaller separate particles. In this way, the friable fat having broken away from the lean when it is flexed, crushed, bent, or twisted, thereby reduces the fat matter into small separated particles. Hence, these are referred to herein as fat particles. The remaining particles are relatively larger comprising mostly lean matter (because they are generally not broken into small particles). Hence, these are referred to herein as lean particles. The change in physical breakdown of the beef particles into two types of particles is caused by lowering the temperature thereof followed by physical disruption of the bond, which fixes the fat and lean matter together in an attached state, and results in a size difference between the larger lean particles compared to smaller fat particles. (stopped)

Following rapid chilling of the diced beef particles in block 144, in one embodiment, the temperature (at the surface of the particles) of the diced beef should be such that the lean matter in the beef particles is greater than 26° F. (preferably such that the water is frozen but the lean matter remains flexible), and the fat matter should be greater than 0° F.

In one embodiment, it has been found that by reducing the temperature of the beef particles with fat in the chill block 144 to a range of between less than 29° F. and above 26° F., the process described above will facilitate separation by providing friable fat fractures permitting the fat to crumble into small fat particles, leaving the lean matter as larger lean particles.

After the chill block 144, the temperature of the fat (at its surface) is lower than the temperature of the lean in each particle. In one embodiment, the surface temperature of the fat matter is lower (approximately 5° F.) than the surface temperature of the lean matter, which is shown to be about 29° F., immediately following discharge from the freezer. The temperature at the surface of fat matter may be at about 5° F. or less and up to 10° F. or more such that it can be friable and crumble upon application of pressure, while the temperature of the lean matter may be 16° F. to about 34° F., or alternatively below 29° F., which makes the lean matter flexible and not frozen into a “rock-hard” condition immediately after removal from the chilling block 144.

The above description of creating friable fat prone to crumble is attributed to the respective differences in the heat transfer ability of fat compared to lean. Table 1 below shows representative temperatures of fat and lean upon leaving the chill block 144 for one embodiment. The temperature of the lean and fat matter is separately plotted against elapsed time. As can be seen, the temperature of the lean matter can be above the temperature of the fat matter for about 5 minutes subsequent to discharge from the chiller and at about 6 minutes (after discharge from the chiller) the lean and fat temperatures have equilibrated.

In one embodiment, immediately after leaving the chill block 144, the fat can be at a temperature of 5.2 F. (at the surface), while the lean is at a temperature of 29 F. The individual pieces of beef containing both fat and lean matter are exposed to the chiller on the order of minutes, generally, between 2 and 3 minutes to create friable fat matter prone to crumble under a crushing force, whereas the lean matter remains pliable, flexible, and not prone to crumble under a similar crushing force. The temperatures will then begin to converge to equilibrium; therefore, it is useful to process the particles of beef in the bond breaking block 146 before the fat is no longer friable and easy to crumble.

TABLE 1
Temperature Difference of Fat and Lean

| | | | | | Temperature | |
|---|---|---|---|---|---|---|
| | Date | Time | delta T′ | delta T | Fat | Lean |
| 1 | Aug. 3, 2010 | 3:31:00 PM | 0:00 | 0:00 | 5.2 | 29.0 |
| 2 | | 3:37:00 PM | 0:06 | 0:06 | 27.9 | 26.6 |
| 3 | | 3:43:00 PM | 0:06 | 0:12 | 29.5 | 26.9 |
| 4 | | 3:50:00 PM | 0:07 | 0:19 | 30.9 | 27.8 |
| 5 | | 3:58:00 PM | 0:08 | 0:27 | 29.7 | 28.6 |
| 6 | | 4:03:00 PM | 0:05 | 0:32 | 30.6 | 28.9 |
| 7 | | 4:14:00 PM | 0:11 | 0:43 | 31.0 | 29.5 |
| 8 | | 4:22:00 PM | 0:08 | 0:51 | 32.8 | 29.8 |
| 9 | | 4:31:00 PM | 0:09 | 1:00 | 33.3 | 30.0 |
| 10 | | 4:36:00 PM | 0:05 | 1:05 | 35.3 | 30.0 |

The stream of temperature reduced beef particles can then be immediately, without storing in containers or otherwise that could allow temperature equilibration of the fat and the lean matter or on an extended conveyor, be transferred to the bond breaking block 146. In bond breaking block 146, the beef particles are “flexed” or bent by distortion and partially crushed as they are transferred between, for example, a pair (two) of parallel rollers manufactured from any suitable stainless steel such as SS316 or SS304 grades, but wherein the beef particles are not completely flattened as would occur if placed on a hard surface and rolled upon with a very heavy roller (steam/road roller for example). This bond breaking compression process is intended to cause breakage of the friable fat matter into smaller particles of, in the majority of instances, approximately 100% fatty adipose tissue (fat), and smaller than the lean matter which remains in most cases intact but without any more than about 10% fat, or less. The fat in the beef particles will “crumble”, fracture, and break into small particles and separate from the lean matter in a continuous stream of what becomes small (smaller than before transfer through the crushing process) fat particles and lean particles that still comprise some fat, but are approximately more than 90% lean beef.

A suitable bond breaking device may comprise at least one or more pairs of horizontally disposed and opposed rollers, arranged so that one pair is above the other, such that the stream of beef particles are spread out across the full width of a conveyer. The beef particles would then be dropped in a waterfall effect between the upper pair of rollers which clamp the particles and flex so as they are transferred between the clamping rolls without crushing and in this way cause the friable fat matter attached to any flexible lean matter to break away in small particles. After processing between the upper pair of rollers, the stream of beef particles drops between the second pair of similarly arranged rollers to ensure processing of all particles before buoyancy separation.

Following the bond breaking block 146, the beef particles, once a combination of lean and fat matter, are now smaller particles of predominantly all fat particles and predominantly all lean particles owing to the breaking of the fat matter from the lean matter. The lean particles and the fat particles are next separated. Separation may be done in batches or continuously. For example, the lean particles and the fat particles are accumulated in a hopper until a sufficient amount has been collected to provide for the next separation batch in the separation equipment.

Following the compression, the chilled beef particles comprising fat particles and lean particles are blended with a selected fluid 148. The mass or volume ratio of frozen beef particles to fluid should be between 1:1 and 1:10. However, the ratio of chilled beef to fluid can be such that when the suspension of beef particles is exposed to UVc in a conduit there is sufficient space between particles to allow UVc direct line of sight contact over the entire surfaces of the beef particles. Enough fluid 148 is provided so as to enable the suspended beef particles comprising lean particles, fat particles, and sufficient fluid to facilitate suspension of the beef particles and facilitate rotation of the particles suspended in the fluid.

In addition to decontamination, separation of the fat particles from the lean (having some fat) particles can be done by way of buoyancy separation in a fluid that has a density lower than that of the lean particles when the water in the lean particles is not frozen. This is because during the chill block 144, water in the lean particles will become frozen and expand, which correspondingly decreases the density of the water containing lean beef particles. In the disclosed process, chilled lean particles containing frozen water may float in the fluid when initially combined with the fluid, which has advantages, but, as the lean particles travel in the fluid, temperature equilibration occurs and the water in the frozen lean particles thaw, thus increasing the density and making separation from the fat particles easier which remain buoyant. The period during which the water remains frozen so that lean particles are less dense than fluid can be advantageously used during decontamination of the particles within the UVc devices. Separation may also be conducted with a fluid that has a density greater than that of the fat particles. Separation may also be conducted with a fluid that has a density in the range between the fat particles and the lean particles. Fluid 148 may be added after bond breaking block 146. The fluid can include water, or water with carbon dioxide, which results in the production of carbonic acid. Fluids 148 include distilled or de-ionized, temperature controlled water, or aqueous solutions of inorganic acids, such as hydrochloric and/or hypochlorous acids, or sulfuric acid or carbonic acid, or aqueous solutions of organic acids such as ascorbic, acetic or lactic acids or others, or, alternatively, aqueous salt solutions comprising water and sodium chlorite or sodium chloride to increase density and to provide an anti-microbial effect when the sodium chlorite solution laden beef particles are immersed in low pH carbonic acid, ascorbic acid, or other suitable acid. Fluids can also include compressed gases, such as nitrogen, or carbon dioxide at a pressure sufficient to maintain the carbon dioxide as a liquid, semi-liquid, and/or as a dense fluid, such as super critical phase carbon dioxide, to maintain the carbon dioxide at a desired specific gravity, such as between about 70 lbs/cu. ft. to about 25 lbs/cu. ft. but in a transparent and fluid phase condition. In one embodiment, the carbon dioxide can be at a pressure of about 300 psig to about 450 psig, which is the pressure range at which carbon dioxide is a liquid from about 0° F. to about 24° F. Additionally, the liquid carbon dioxide may be passed over frozen water (ice) or otherwise combined with water to produce carbonic acid. In one embodiment, the temperature of the fluid 148 should be not less than about 40° F. and not greater than about 60° F., but most preferably at about 50° F., before being mixed with the beef particles. In one embodiment, when the beef particles and fluid are mixed together, whether enclosed within conduits (or tubes), an enclosed vessel, a centrifuge, hydro-cyclone, or other equipment, the equilibrated temperature of the fluid should not be less than about 31° F. to about 40° F., but most preferably at about 32° F. to 34° F.

At the temperatures required for bond breaking discussed above, when the fluid 148 is first mixed with the lean and fat particles, the particles including the lean particles, will preferably float and be suspended at the uppermost space available in the fluid and just below a surface of the fluid or suspended within the fluid. Initially, the lean particles being less dense than the fluid is advantageous to allow their decontamination, as the lean particles (an also the fat particles) will be suspended in the fluid and will not settle to the bottom of conduits or vessels. As the temperature of the fluid and fat and lean particles begins to equilibrate, which involves the initial lower temperature of the lean particles increasing, corresponding with the decreasing temperature of the fluid, the buoyancy of the lean particles will start to “fail.” Eventually, the lean particles sink toward the base of the fluid leaving the fat particles floating at the fluid surface or uppermost available space in the fluid. An increase in the density of the lean particles is seen as the lean and water thaw, which reduces the volume of lean particles and correspondingly increase in density. Fat having a lower content of water does not experience as great an increase in density due to water thawing.

Before the lean particles and fat particles have reached equilibrium with the fluid, any bone chips that may be present will sink when mixed together with the fluid, thereby providing a convenient means of separating bone chips first, which will most preferably be arranged to occur immediately after blending the lean and fat particles with the fluid and before temperature equilibration of the particles or when the lean particle temperature has increased so as to thaw the lean/water content of the lean matter upon which shrinkage of the lean will occur causing it to sink in the fluid. The fat particles, frozen or not, will remain floating at the fluid surface. By lowering the fluid temperature relative to the temperature of the lean particles, complete thawing and temperature equilibration will be delayed, and, accordingly, the lean particles will remain suspended for a longer period, and this can assist with UVc pathogen deactivation as described below.

The lean and fat particles suspended in the fluid 148 is at a suitable mass or volume ratio of fluid to particles in the range of 1:1 to 5:1, or 10:1 to 1:10 by weight. Before temperature equilibrium is reached, and the lean particles sink, the lean and fat particles can be decontaminated, such as by treating with exposure to UVc light, which is lethal to pathogens when the exposure is sufficient in block 106. The suspension of frozen lean and fat particles in sufficient fluid can be transferred at a steady rate through an enclosed/sealed internally polished (preferably stainless steel) tube within which an elongated, tubular profiled, UVc light source is mounted in parallel with the enclosing stainless steel tube. As the temperature of the mixture steadily equilibrates, the outer surface of the lean and fat particles thaws, and, if pathogens are present, the single celled organisms will be at the surface of the beef particles or suspended in the fluid, but, in any event, at locations readily accessible to the direct “line of sight” of the UVc light source given that the particles revolve while suspended in the fluid. UVc is lethal to such pathogens as E. Coli 0157:H7 and Salmonella and such pathogen contamination can be deactivated by adequate exposure to UVc. The particles suspended in the fluid revolve randomly as the mixture is transferred through the UVc device 106. Pathogens are quickly deactivated when exposed to the UVc light source, particularly when the UVc wavelength has been selected from either 100 nanometers to 300 nanometers or, more particularly, in the immediate range of the effective germicidal wavelength of 285 nanometers; or 200 nanometers to 300 nanometers wavelength or in the immediate germicidal wavelength of 185 nanometers.

The following indicates the wavelength in nanometers (nm) for UVa, UVb, and UVc:
UVa—420 nm-320 nm;
UVb—320 nm to 285 nm;
UVc—285 nm to 100 nm.

Most preferably the UVc wavelength of the UVc light source to which the above-referenced beef particles will be exposed will be in the ranges of 250 nm to 100 nm or 150 nm to 100 nm.

The fluid 148, such as water, is preferably transparent to the wavelength of the energy produced by the UVc source. Additionally, the fluid should remain clear and distinctly separated from the fat and lean particles, without absorbing any organic component such as blood or any other separated food item such as, for example, fat particles or, alternatively, what is commonly known in the meat processing industry as “bone dust” that could otherwise reduce the transparency of the fluid by becoming “milky,” which would inhibit the UVc anti-microbial effectiveness. The particles are preferably not densely packed within the UVc device 106. More preferably, the particles can be fluidized within the UVc device 106. This can occur because the density of the lean particles is still less than the density of the fluid, and the lean particles have not yet equalized in temperature with the fluid, and the water is not completely thawed that would lead to an increase in density. Accordingly, the method disclosed takes advantage of this, and, during the period when the density of the lean particles is less than the density of the fluid, the flow of fluid can be directed vertically. The particles may tumble and rotate randomly so that all surfaces, and especially the un-cut and “older” surfaces of the particles, are exposed to the energy being produced by the UVc device or being reflected from reflectors. Preferably, the fluid is transparent to and allows the passage of the particular wavelength energy without much attenuation. UVc devices include a UVc transparent tube through which the fluid and particles pass. Direct energy produced by the UVc device is allowed to penetrate the walls of the transparent tube and directly strike the surfaces of the particles being carried by the tube. Additionally, reflected energy from reflectors bouncing also passes the walls of the transparent tube to strike the surfaces of the particles. Preferably, the flow within the transparent tube may be turbulent so as to create a mixing motion of the particles, so that all surfaces of the particles are eventually exposed to the energy being produced before exiting from the distal end of the tube. The UVc transparent tubes are made of a length that is adequate so that it can be assured that all food particles within the tube are eventually exposed to the energy. If it is determined by empirical testing that the pathogen or bacteria population of the food product is not reduced to an undetectable level, the length of the transparent tubes can be increased until it is determined that no viable pathogenic bacteria remain.

Referring back to FIG. 1, from the bond breaking block 146, the fluid 148 is added to be mixed with and carry the fat and lean particles to block 104. The fluid 148 can be clean, potable water or other liquids or a combination of liquids with agents. Liquids may include water, or liquid carbon dioxide, or both. The liquids may further include acids, either organic or inorganic, and alkaline agents. Acids include, but are not limited to carbonic acid (water and carbon dioxide), lactic acid, ascorbic acid, acetic acid, citric acid, peracetic acid also known as acid (CH₃CO₃H). Alkalinity of the liquid may be raised by adding an alkali substance, such as ammonia, ammonium hydroxide, sodium hydroxide, potassium hydroxide, calcium hydroxide, tri-sodium phosphate, and any other suitable alkali. Additives such as sodium chloride, sodium chlorite, and sodium hydroxide may be added which can be followed by addition of a suitable acid (to provide acidified sodium chlorite). Block 104 is a positive displacement pump. Pump 104 pumps the liquid with the fat and lean particles into block 106.

Block 106 is the first UVc device. It should be appreciated that UVc is mentioned as one representative means for decontamination for purposes of illustrating one embodiment of the invention, however, the invention is not thereby limited to UVc. Other energy of wavelengths not in the UVc range and that are shown to be lethal to pathogens may also be employed. Suitable UVc devices are described below. Block 106 can include one or more ultraviolet C devices. In block 106, the ultraviolet C devices are positioned vertically. The densities of both the fat and lean particles immediately following transfer from the chill block 144 and bond breaking block 146 are less than the fluid 148, therefore, the first UVc device(s) 106 can be oriented in a vertical or near vertical disposition. In this way, the fluid with the suspended particles (which tend to float initially in the fluid before the temperature increases such that the frozen water in the particles thaws) can be transferred through an annular space between an inner and outer UVc light source formations, as seen in FIG. 4, (about 2-inch distance between outer surface of the inner tubes 60 and the inner surface of the outer tubes 51).

From block 106, the process enters block 108. Block 108 includes second ultraviolet C devices. Ultraviolet C devices in block 108 can be positioned horizontally. In block 108, the temperature of the fluid begins to thaw the water in the lean particles, thus, the density of the lean particles begins to increase. The lean particles are denser than the fluid causing the lean particles to settle to the bottom of the conduit. As the mixture of solids and fluid are transferred along the horizontal block 108, temperature equilibration between the solids and fluid increases the density of the lean matter as the formerly frozen water thaws and shrinks. The lean and fat particles quickly separate as temperature equilibration occurs, causing the density of lean to increase causing the fat and lean solids to diverge as they are carried with the flow. The fat matter remains buoyant, carried by the fluid at a higher elevation than the lean matter and the lean particles fall to the lowermost section of the conduit through which they are still propelled by the flow of fluid.

From block 108, the process transfers fluid and particles to separation block 110. A separation vessel 110 is constructed so that following temperature equilibration of the particles, a conduit 132 connected directly to the underside of the separation vessel 110 and extending downward, allows the lean particles with some fluid to be separated from the main fluid. An opposing conduit 130, attached directly to the upper side of the separation vessel 110, allows the fat particles and some fluid to diverge upwardly and in this way, the fat and lean particles are divided into two streams, wherein the lean particles (“matter”) flow in one conduit 132 and the fat particles (“matter”) flow in a separate conduit 130. Block 110 is sized to provide sufficient settling time to allow the separation of lean particles from fat particles. The time can be adjusted so that some of the fat particles do not have time to float to the surface and are carried with the lean particles, thus increasing the fat content of the lower stream. This is desirable to control the fat percent of the produce removed from the lower conduit. Lean particles being denser than the fluid will settle to the bottom of separator 110. Fat particles being less dense than the fluid will float to the top of the separator 110. Separator 110 includes a top outlet and a bottom outlet. The top outlet is for collecting the fat particles that rise to the top of the fluid. The bottom outlet is for collecting lean particles that settle on the bottom of the separator. From separator 110, lean particles travel through block 116. Block 116 is a third UVc device. Fat particles being lighter than fluid in the separator will float to the surface. Fat particles will travel through block 112. Block 112 is a fourth UVc device. From block 112, fat particles and fluid enter conduit 136. Fat particles and fluid in conduit 136 will enter the fat accumulation vessel 114. The fat accumulation vessel 114 includes a gas pressure regulation port 120 at that top section of the vessel 114. The fat accumulation vessel 114 includes a fat extraction port 122 at the bottom section of the fat accumulation vessel 114. From conduit 132, lean particles and fluid enter UVc device block 116. From block 116, lean particles and fluid enter conduit 138. Lean particles and fluid in conduit 138 will enter the lean accumulation vessel 118. The lean accumulation vessel 118 includes a gas pressure regulation port 124 at a top section of the lean accumulation vessel 118. The lean accumulation vessel 118 includes a lean extraction port 126 at a bottom section of the lean accumulation vessel 118.

As described above, the third and fourth UVc devices 112, 116 are arranged to allow the fat particles to separate and, combined with an adequate portion of the fluid, form a second stream which is transferred from the second horizontal UVc device 108 into an upwardly disposed UVc device 112 while the remaining lean particles and fluid comprising a third stream, are transferred from the second horizontal UVc device 108 into a downwardly disposed UVc device 116. The separation vessel 110 connects the incoming single stream with third and fourth devices 112, 116. The conduits 130 and 132 for the separation of fat particles and lean particles can be tubes arranged at an incline and decline, respectively, so as to allow fat particles to float and the lean particles to settle. The vertical and horizontal orientation of the UVc devices facilitates transfer of the fluid with suspended beef particles.

Minimizing the period of direct exposure of the chilled beef particles to the fluid in which the beef stream is suspended is desirable to avoid excessive loss of micronutrients or plasma which can leach from the beef particles into the fluid.

It is also preferable to eliminate any free oxygen gas from the input stream so as to prevent the possibility of ozone (O3), which can readily cause taste quality deterioration by causing rancidity of the fats.

In another preferred embodiment, the separated streams of lean and fat can be exposed to subsequent, separate, additional pathogen deactivation treatments to ensure reduction of pathogen populations to undetectable levels. Boneless beef, when infected with Pathogens such as E. Coli 0157:H7, will generally comprise a fat component which will likely include a predominant proportion of the total pathogen population while the lean component will likely comprise a lower pathogen population. This occurs because pathogen contamination generally occurs due to contact with any vector of pathogen contamination by the outer surface making contact therewith. The outer surface of a beef carcass is generally substantially covered with a fat layer hence the fat component of boneless beef and trim will often comprise the major proportion of any pathogen contamination contained with a given quantity of boneless beef. Separating the fat component from the lean component can, therefore, provide a means of dividing the pathogen population with a greater proportion carried with the fat component and less with the lean part. The fat stream includes protein of significant value, even after separation from the lean component and fat with proteins can be heated to higher temperatures than the lean can be such as above pasteurization temperature of 160° F. and higher. However, the lean component cannot be heated without causing unacceptable changes in color and composition. Therefore, the proteins contained in the fat component can be separated and then recombined with the lean component without affecting the finished high lean content product. Furthermore, when 30's (XF's) or 50's boneless beef are separated into two streams of: 1) a fat and beef proteins component; plus, 2) lean beef of say 90% or 93% lean content, an opportunity to subject each stream to different pathogen deactivation treatments is available. Most preferably, the fat stream (with proteins) can be pasteurized by elevating temperature of the stream to above a pasteurization temperature of greater than 160° F. while the heat sensitive lean stream can be most preferably treated to reduce pathogen populations in super-critical carbon dioxide and according to the method described in the US Patent Application Publication No. 2010/0075002, to undetectable levels while the predominantly fat stream (and proteins can be pasteurized thermally by increasing its temperature to greater than 160° F. or greater than 190° F. Accordingly, after separation of the lean component from the fat component followed by separation of the lean stream from the fluid with which it (and the fat stream) was combined prior to separation of fat from lean and then immersed in super critical carbon dioxide according to a treatment described in the referenced patent applications. Such a pathogen deactivation process, as disclosed, for example in US Patent Application Publication No. 2010/0075002, entitled TREATMENT TO REDUCE MICROORGANISMS WITH CARBON DIOXIDE BY MULTIPLE PRESSURE OSCILLATIONS, which is hereby incorporated with this patent application for all purposes, can effectively reduce pathogen populations to undetectable levels without affecting the appearance of the lean components. Separately, the fat stream, which can contain substantial quantities of proteins, can be homogenized and then pasteurized by heating to an elevated temperature of, say greater than 190° F. or at least above 160° F. or higher such as 200° F. or more which will render all pathogens inactive. The heat pasteurized stream of fat and proteins is then centrifuged to separate the liquid fat (tallow) from the proteins and any remaining water. The proteins and water can then be recombined with the lean stream without any deleterious effect on appearance of the fresh lean beef.

The fat stream or tallow stream can then be combined with less than 15% added water (by weight) in a blend including 85% fat. The combined and blended mixture of fat (85%) plus water (15%) can then be homogenized to provide a uniform tallow containing 15% water.

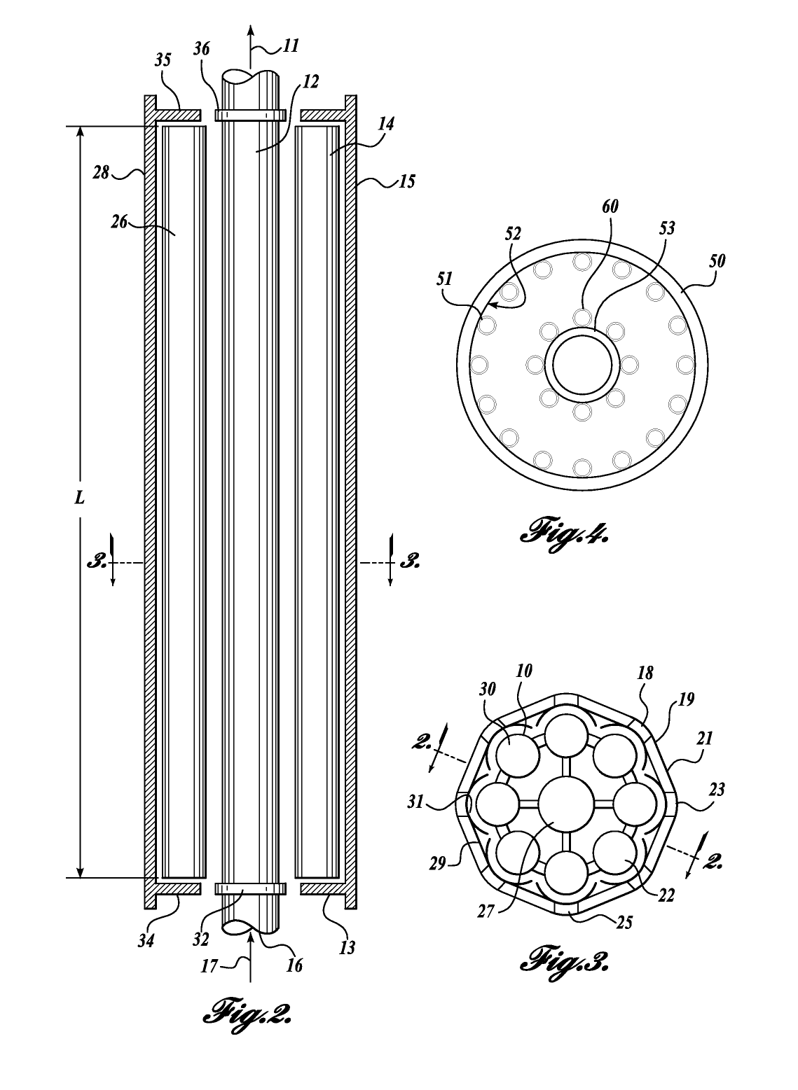

Referring to FIGS. 2-4, the UVc devices of blocks 106, 108, 112, and 116 will be described. Blocks 106, 108, 112, and 116 may each include a plurality of UVc devices, arranged serially or in parallel with one another. In the UVc embodiment of FIGS. 2 and 3, the UVc devices include a central tube 12. The tube 12 is transparent to certain wavelength energy, such as ultraviolet and, particularly, to ultraviolet C. However, other wavelength energy can be used as long as such different wavelength energy can penetrate the tube without affecting the anti-bacteria, bactericidal effectiveness of the penetrating energy or alternatively, the effectiveness or capacity of the energy penetrated tube to remain capable of retaining the pressurized liquid retained by the tube and through which it is transferred. For example, it is known that ultraviolet light, including UVc, can render extruded, transparent uPVC tubing having gas barrier and high pressure rating conduit qualities, to become a translucent yellow coloration with brittle or friable consistency, which then, therefore, renders it useless for high pressure liquid retention. Alternative forms of energy can include electron beam, irradiation, microwave, X-ray, infrared, or the like. Ultraviolet C radiation is generally considered to be light energy having a wavelength from 200 to 290 nanometers. In one embodiment of the tube 12, the tube 12 is also transparent to visible light. Further, in one embodiment, the tube 12 can be made from polycarbonate or other such materials that can withstand a pressure of about 10 psig to about 3,000 psig, which is the pressure range at which carbon dioxide is a liquid from about (minus 60° F.)−60° F. to about (plus 87.9° F.)+87.9° F.

The tube 12 can be incorporated into any conduit that carries food material. For example, the tube 12 can be connected at a proximal and distal end of a stainless steel tube 16. The tube 12 is held to the end of the stainless steel tube 16 via clamp 32 on one side and via clamp 36 on the opposite and distal side. In FIG. 2, the proximal side is considered the side on which clamp 32 is located. The distal side is considered the side on which clamp 36 is located. Arrow 17 is intended to indicate the direction of flow of material through the tube 12, whereas arrow 11 shows the direction of material exiting from the tube 12. Although FIG. 2 illustrates the apparatus as being vertically disposed, the device does not need to be placed in the vertical position and may be placed in any other position relative to the ground. The device includes one or more energy emitting elements, such as energy emitting elements 14 and 26. The energy emitting elements 14 and 26 are generally disposed parallel to the tube 12 and also extend generally the same length as the tube 12 or extend beyond and overlap the ends of the clear section of the transparent conduit 12, that is, the one or more energy emitting elements 14 and 26 extend from the proximal side of the tube 12 to the distal side of the tube 12. A space or gap may be provided between the side of the energy emitting elements 14 and 26 and the side of the tube 12, although this is not a requirement.

As seen in FIG. 3, in one embodiment, more than one energy emitting element may be provided. Generally, the tube 12 may be centrally located and enclosed within an arrangement, whereby energy emitting tubes, such as 14 and 26, are located in an array or circular arrangement around the central tube 12 and disposed at an equal distance from the tube 12, so that the energy emitting elements may project entirely around the circumference of the tube 12. The energy emitting elements may be evenly spaced around the circumference of the tube 12. However, a single energy emitting element may be manufactured as a unitary cylinder that also extends approximately the whole length of the tube 12. In the case where multiple energy emitting elements are used, each energy emitting element may take the form of a tube. In this case, each individual tube is paired with a reflector, such as parabolic reflector 31. Reflector 31 extends the length of the energy emitting element with which it is paired. Reflector 31 is concave or paraboloid (parabolic) to focus or direct reflected energy to the tube 12. Reflector 31 is positioned so as to reflect all energy beams or rays inward toward the center of the tube 12 and thereby concentrate and/or direct the energy produced by the energy emitting element towards the center of tube 12, which, in the illustrated embodiment, is disposed at the center of the assembly. A suitable frame, such as 15, may be used to hold the individual energy emitting elements in the desired spatial relationship with respect to the central tube 12 and with respect to each other. Additionally, an exterior frame 15 may be used to hold each individual reflector 31 that is paired with each individual energy emitting element in the desired spatial relationship with respect to the energy emitting element and to the central tube 12. For example, as seen in FIG. 2, each individual energy emitting element, such as 26, is held within the frame 15 with an upper and a lower bracket, such as brackets 35 and 34, respectively. Each reflector that is paired with an energy emitting element is attached to the inside of the frame 15. However, any other suitable frame made to hold energy emitting elements and reflectors may be used.

In another embodiment of a UVc device, the cross section of which is seen in FIG. 4, the open frame 21 may be replaced with a stainless steel tube 50 having an interior diameter sized to accommodate central tube 53, and further sized to accommodate 1 (one) inch diameter fused quartz tubes 51 on the inner surface 52 of the stainless steel tube 50. Each of the fused quartz tubes 51 hold a UVc light in the interior thereof. The UVc lights (also tubes) are enclosed in fused quartz tubes with an air space between the light tube and the fused quartz tube. The air space insulates the light tube from the direct chilling effects of the chilled suspension fluid passing in the annular space between the central tube 53 and the outer tube 50. While air is used in one embodiment, the space between the UVc light and the interior of the fused quartz tube may also include other gases, either essentially pure, or as a mixture, such as nitrogen, carbon dioxide, hydrochlorofluorocarbons (HCFCs), hydrofluorocarbons (HFCs), and the like. The UVc lights may use low pressure mercury vapor to generate the UVc radiation. In particular, a wavelength in the 240 to 280 nanometer range can be used. In one embodiment, the wavelength for disinfection can be about 260 nm.

The central tube 53 can be made from materials similar to tube 50. A plurality of fused quartz tubes 60 (with UVc lights) are placed on the exterior of the central tube 53, such that an annulus space is created between tubes 53 and 50. Deflectors may be arranged in and around the annular space and UVc tubes to cause rotation of the beef particles so as to cause exposure of all surfaces of the beef particles to the UVc radiation, and deflect the solids (beef particles) to inhibit contact with the quartz tubes so as to prevent smearing of fat onto the warm fused quartz tubes or cause other damage and/or breakage. For example, deflectors, such as thin fins can be placed in a spiral configuration on the inside of the surface of the tube 50 and before the fused quartz tubes 51. The inner surface 52 of the stainless steel tube 50 is polished to reflect energy toward the central tube 53. Thus, eliminating the reflectors 31 shown in FIG. 2. In one embodiment, the inner surface 52 of the stainless steel tube may hold up to fifty fused quartz tubes with UVc lights inside. In one embodiment, thirty fused quartz tubes 51 may be placed around the circumference of the inner surface of the stainless steel tube 50 and twenty of the fused quartz tubes 51 may be placed around the circumference of the outer surface of the central tube 53. However, the number of UVc tubes may be varied based on outer tube 50 or central tube 53 diameter. In other embodiments, UVc devices may use fewer or more UVc tubes. The beef particles may pass in the annulus created between the tubes 50 and 53. The beef particles and fluid, which may include water, comprise a suspension and the temperature of the fluid is controlled, such as by chilling, to prolong the presence of frozen water retained in the beef so as to minimize loss of blood, plasma, and micro-nutrients. The suspension comprises the fluid 148 and the beef particles, having been processed through the dice, chill, and bond breaking steps 142, 144, and 146. The amount of fluid is sufficient to allow the beef particles, including fat and lean, to be suspended in the fluid. The amount of fluid which suspends the beef particles allows rotation of the beef particles in the fluid so as to cause exposure of all surfaces of the beef particles to the UVc radiation. The UVc tubes 51 and 60 on the respective tube surfaces allow the beef particles to be irradiated with UVc energy from two opposing directions as the beef particles pass within the annulus. The fluid may need to be filtered after use if it is to be recycled so as to remove all suspended solids including dead microorganisms.

The heating effect of UVc light sources can be significant. For example, a single device (enclosed tube) can use 23×>60 inch UV lights at up to about 190 watts per light, which represents 3.6 kW of electrical power consumed per device. With three devices arranged in series, the electrical power consumed during operation can be 11.0 kW for 3× “tubes.”

The projected area of a light source, assuming a single >60-inch long, 190 Watts UV light located within a one-inch diameter fused quartz tube, is approximately 60 inches×1 inch (about 60.0 sq. inches). Then, twenty three (23) such lights arranged in two concentric, circular formations, wherein the inner arrangement comprises seven (7)>60-inch UV lights each being enclosed within a one-inch diameter fused quartz tube will have a total projected area (one side) of 420 in², and the outer arrangement comprises sixteen 60-inch UV lights each being enclosed within a one-inch diameter fused quartz tube will have a total projected area (one side) of 960 in². This represents the maximum density (11.0 kW per 1,380 in²=7.97 Watts/in²) when all lights are enclosed (and sealed fluid tight) in individual fused quartz tubes.

If the UVc light bulbs are not enclosed in fused quartz tubes and the UV light bulb has a diameter of about 0.625 inches, but the cooling effect of the fluid would inhibit generation of UVc.

No molds, viruses, bacteria or micro-organisms are thought to survive when exposed to sufficient UVc light and the UVc device should be constructed to facilitate the delivery of 40 mJ/cm².

In one embodiment, the space between the fused quartz tubes 51 and the central tube 53 can be immersed with nitrogen gas transferred in and out via an inlet and outlet. The nitrogen or other cooling media can be used in sufficient volume to cool and maintain a suitable temperature.

In the embodiment of FIG. 1, ultraviolet C radiation passes through the walls of the central tube 12 where it can strike the beef particles including fat particles and lean particles passing within the inside of the tube 12. The fluid in which the lean particles and the fat particles are immersed is in a greater volume proportion than the combined particles. A suitable amount of fluid is added such that the lean particles and the fat particles can freely revolve in the fluid. This allows the particles to rotate in the fluid as the fluid is transferred in the central tube 12. The velocity of the fluid can be increased to induce turbulence, thus creating more rotation of the particles. The purpose of causing the particles to rotate in the fluid is to expose all surfaces of the particles to the ultraviolet C radiation.

One embodiment of the central tube 12 as shown in FIGS. 2 and 3 is of round cross-sectional profile, and a round profile is convenient since tube extruding dies are typically built so as to produce round tubing, however, any suitable profile can be incorporated and most preferably any profile that can most effectively expose the outer surfaces of all fat and lean particles to the UVc light. The lethal or bactericidal effectiveness of the UVc light is enhanced when the distance between the UVc light source and the external surfaces of each particle, carried by the fluid, is minimized, and this can be achieved by reducing the depth of the transparent tube 12 or thickness across the tube.

The electrophoresis effects of short wavelength light (UVc) causes damage to the DNA of bacteria, thereby rendering the bacteria non-viable. An effective bactericidal UVc light wavelength has been demonstrated to be in the range of 187 nanometers, however, the conditions required to enable this UV wavelength to contact the bacteria carried on the food surfaces are challenging in a food mass production apparatus. Provided herein is a method and apparatus wherein the short wavelength bactericidal benefits of UV light can be applied in mass processing of, in particular, beef particles.

The space between the UVc light and the interior of the fused quartz tubes 51 and 60 may comprise a vacuum or dry nitrogen gas filled space. In one embodiment, UVc of about 285 nanometers wavelength is suitable. Water cannot be in direct contact with the UVc light's glass, for example, low pressure, high temperature mercury vapor lamps, nor indeed can the organic matter itself be in contact with the UVc light given the high temperature conditions required to generate UVc light. It is therefore useful to provide materials that are transparent to the selected UVc light wavelength, between the UVc light source and the treated matter. Materials that have been used to provide UV light transparent barriers include certain gases such as nitrogen, water, PMMA (Poly-Methyl-Meth-Acrylate), or acrylic and fused quartz glass; however, these materials generally limit the use of UV light to wavelengths at about 285 nm. A most suitable material is synthetic UV grade quartz glass or UV grade fused silica which allows 80% penetration of UVc 185 nm wavelength.

Quartz glass tubes 51 and 60 can be manufactured from fused silica having a thickness of about 10 mm so as to allow UVc of wavelength 160 nm to pass through and contact the surfaces of beef particles being carried past the quartz tubes 51 and 60. It should be noted that the temperature of the fluid can be maintained at about 40 degrees F. or less, such that a film of ice can form over the beef particles in one instance having a thickness that does not inhibit the transfer of UV light therethrough or, alternatively, the temperature of the fluid in contact with the beef particles causes thawing only at the surface of the beef particles. In this way, UV light of wave length 160 nm or in another instance 285 nm generated by UV lights can penetrate the fused silica walls of tubes. The chilling and transfer of beef particles in the way described causes a continuous revolving/rotating movement of the beef particles so as to ensure that all surfaces are exposed to the UV source. In one embodiment, multiple UV sources are arranged in close proximity to the outer surface of any conduit carrying lean and fat particles, wherein alternate UV sources are provided. For example, a UV source is firstly a UV generating source of about 160 nm wavelength and the alternate UV source is a UV generating source of about 285 nm wavelength. Furthermore, the UVc devices of blocks 106, 108, 112, and 116, can used similar energy or different energy as any other block. Furthermore, devices of different wavelength energy can be used within a single device.

In view of the disclosure herein, various methods are disclosed.

One embodiment of a method includes (a) dicing beef into diced particles; (b) chilling the diced particles into chilled particles; (c) compressing and/or flexing the chilled particles to separate fat from the chilled particles to produce fat particles and lean particles; (d) mixing the fat particles and lean particles with a fluid, wherein a density of the lean particles is initially less than a fluid density; (e) treating the lean particles and fat particles with energy harmful to pathogens as the fluid and lean and fat particles pass through an energy-emitting device at least while the lean particles are less dense than the fluid; (f) increasing the temperature of the lean particles to increase the density which causes the lean particles to sink in the fluid; and (g) separating the lean particles from the fat particles. The particles are suspended in fluid to allow rotation of the particles in the fluid as the particles pass through an energy-emitting device.

In one embodiment, The energy used in the method disclosed herein may be UVc energy.

In one embodiment, the temperature of the lean particles is lower than the temperature of the fluid in step (d).

In one embodiment, the temperature of the lean particles is substantially at equilibrium with the temperature of the fluid in step (g).

In one embodiment, the fluid includes water, or water and one of carbon dioxide, an acid, or an alkali agent.

In one embodiment, the energy is UVc energy having a wavelength of 285 nm to 100 nm.

In one embodiment, the method may further include treating the lean particles and fat particles with energy harmful to pathogens as the fluid and lean and fat particles pass through an energy-emitting device during step (f) or step (g).

In one embodiment, the energy-emitting device is disposed vertically or substantially vertical with respect to the ground.

In one embodiment, the method may further include treating separated fat particles with energy harmful to pathogens.

In one embodiment, the method may further include treating separated lean particles with energy harmful to pathogens.

In one embodiment, the chilled particles are individualized particles.

In one embodiment, the chilled particles are solid particles.

One embodiment of a method includes treating chilled lean particles and fat particles with energy harmful to pathogens as the particles are suspended in fluid to allow rotation of the particles in the fluid as the particles pass through an energy-emitting device.

In one embodiment, as the particles pass through the energy-emitting device, the lean particles are less dense than the fluid

In one embodiment, the energy is UVc energy.

In one embodiment, the temperature of the lean particles is lower than the temperature of the fluid.

In one embodiment, the fluid includes water, or water and one of carbon dioxide, an acid, or an alkali agent.

In one embodiment, the energy is UVc energy having a wavelength of 285 nm to 100 nm.

In one embodiment, the energy-emitting device is disposed vertically or substantially vertical with respect to the ground.

In one embodiment, the chilled particles are individualized particles.

In one embodiment, the chilled particles are solid particles.

While the preferred embodiment of the invention has been illustrated and described, it will be appreciated that various changes can be made therein without departing from the spirit and scope of the invention.

1. A method for decontaminating beef, comprising:
(a) dicing beef into diced particles;
(b) chilling the diced particles into chilled particles;
(c) compressing and flexing the chilled particles to separate fat from the chilled particles to produce fat particles and lean particles;
(d) mixing the fat particles and lean particles with a fluid, wherein a density of the lean particles is initially less than a fluid density;
(e) treating the lean particles and fat particles with energy harmful to pathogens as the fluid and lean and fat particles pass through an energy-emitting device at least while the lean particles are less dense than the fluid;
(f) increasing the temperature of the lean particles to increase the density which causes the lean particles to sink in the fluid; and
(g) separating the lean particles from the fat particles.

2. The method of claim 1, wherein the particles are suspended in fluid to allow rotation of the particles in the fluid as the particles pass through the energy-emitting device.

3. The method of claim 1, wherein the energy is UVc energy.

4. The method of claim 1, wherein the temperature of the lean particles is lower than the temperature of the fluid in step (d).

5. The method of claim 1, wherein the temperature of the lean particles is substantially at equilibrium with the temperature of the fluid in step (g).

6. The method of claim 1, wherein the fluid includes water, or water and one of carbon dioxide, an acid, or an alkali agent.

7. The method of claim 1, wherein the energy is UVc energy having a wavelength of 285 nm to 100 nm.

8. The method of claim 1, further comprising treating the lean particles and fat particles with energy harmful to pathogens as the fluid and lean and fat particles pass through an energy-emitting device during step (f) or step (g).

9. The method of claim 1, wherein the energy-emitting device is disposed vertically or substantially vertical with respect to the ground.

10. The method of claim 1, further comprising treating separated fat particles with energy harmful to pathogens.

11. The method of claim 1, further comprising treating separated lean particles with energy harmful to pathogens.

12. The method of claim 1, wherein the chilled particles are individualized particles.

13. The method of claim 1, wherein the chilled particles are solid particles.

14. A method for decontaminating beef, comprising treating chilled lean particles and fat particles with energy harmful to pathogens as the particles are suspended in fluid to allow rotation of the particles in the fluid as the particles pass through an energy-emitting device.

15. The method of claim 14, wherein, as the particles pass through the energy-emitting device, the lean particles are less dense than the fluid

16. The method of claim 14, wherein the energy is UVc energy.

17. The method of claim 14, wherein the temperature of the lean particles is lower than the temperature of the fluid.

18. The method of claim 14, wherein the fluid includes water, or water and one of carbon dioxide, an acid, or an alkali agent.

19. The method of claim 14, wherein the energy is UVc energy having a wavelength of 285 nm to 100 nm.

20. The method of claim 14, wherein the energy-emitting device is disposed vertically or substantially vertical with respect to the ground.

21. The method of claim 1, wherein the chilled particles are individualized particles.

22. The method of claim 1, wherein the chilled particles are solid particles.
